(19) United States
(12) Patent Application Publication
(10) Pub. No.: US 2024/0414001 A1
(43) Pub. Date: Dec. 12, 2024

(54) DATA ACCESS CONTROL

(71) Applicant: British Telecommunications Public Limited Company, London (GB)

(72) Inventors: Andrew REEVES, London, Greater London (GB); Nektarios GEORGALAS, London, Greater London (GB)

(21) Appl. No.: 18/696,816

(22) PCT Filed: Sep. 8, 2022
(86) PCT No.: PCT/EP2022/075020

§ 371 Date: Mar. 28, 2024

(30) Foreign Application Priority Data
Sep. 30, 2021 (GB) 2114024.9

(51) Int. Cl. H04L 9/32; H04L 9/00; H04L 9/08

(52) U.S. Cl. CPC H04L 9/3213; H04L 9/0894; H04L 9/50

(57) ABSTRACT

A data access control system is provided together with methods, computer systems and computer programs for processing transactions to be recorded in a distributed ledger that is shared amongst a plurality of computing nodes and for controlling access to data recorded in the distributed ledger. The system comprises a policy store comprising one or more policies for controlling access to at least some of the data recorded in a distributed ledger that is shared amongst a plurality of computing nodes, each policy comprising one or more constraints on accessing the data. The system further comprises a key store for storing cryptographic keys. The system further comprises a transaction processor configured to: receive a transaction from one of the computing nodes: encrypt a payload of the transaction using a secret key to generate an encrypted transaction for recording in the distributed ledger; and store the secret key in the key store in association with an indication of the encrypted transaction. The system further comprises a data access module configured to: receive a request for access to the pay load of the encrypted transaction from one of the computing nodes: determine whether the constraints specified by the one or more policies on accessing data contained in the payload are satisfied; and in response to determining that the constraints are satisfied: retrieve the secret key from the key store; and use the secret key to provide access to the data for the computing node.

### FIELD OF THE INVENTION

The present invention relates to data access control. In particular, the present invention relates to controlling access to data recorded in a distributed ledger to enforce constraints on accessing the data as specified by one or more policies.

### BACKGROUND TO THE INVENTION

Distributed ledger technology (DLT) allows a ledger (or database) to be distributed amongst a number of participant nodes (or computing systems). The nodes participating in a distributed ledger can be spread across different geographical locations (e.g. countries) and may be under the control of different entities. Each participant node maintains their own copy of the ledger and so has access to all of the data recorded in it. Nodes can generate transactions to record (or modify) data in the ledger. These transactions are provided to other participating nodes for approval via a consensus algorithm. If approved, the transaction is broadcast to all participating nodes for recording in their respective copies of the ledger. Since each node participating in a DLT maintains its own copy of the ledger, tampering with the data recorded in the database is generally impractical. However, to further reduce this possibility, DLTs typically employ cryptographic mechanism to allow the ledger to be verified. Transactions in a distributed ledger are therefore generally considered to be immutable. There are many different DLTs that can be used. One example of a DLT is Blockchain, which records transactions in blocks that are strung together sequentially. In Blockchain, each block contains a cryptographic hash of the previous block meaning that the integrity of the entire chain of blocks (or blockchain) can be verified by working backwards from the latest block containing the most recent transaction(s) and checking that the cryptographic hash of the preceding block is correct. These properties of DLTs, in which data can be shared amongst numerous entities in a manner in which tampering with previously recorded data is impossible (or at least impractical), make them ideal for numerous applications.

One area in which DLT can be used is inventory management. In an inventory management system each asset is represented by a digital twin which includes attributes for recording information about the asset, such as its owner, current location, configuration (e.g. device parameters), and so on. In some cases, changes to the digital twin in the inventory management system can result in corresponding changes being made to the physical asset. For example updating a device parameter for an asset in the inventory management system may result in the physical asset being reconfigured to use that device parameter instead of a previous parameter. Although such inventory management systems can be implemented using more conventional (non-distributed) databases, this results in a single entity controlling the data stored in the system. However, in complex supply chains, there may be many assets involved in delivering a service or product to an end customer. Furthermore, there may be many different entities that interact with those assets in order to deliver the end service or product to a customer. For example, assets may be transferred between, configured by or otherwise handled and managed by multiple distinct entities (such as a main service delivery organisation and their partner organisations) in order to deliver the end service or product. In order for such supply chains to be managed efficiently it is necessary for the inventory system to be shared between all entities involved in delivering the service or product so as to ensure all entities can access a reliable and current view of the inventory. It is also necessary for the inventory management system to contain an irrefutable record of the actions that have been taken by the entities involved in the supply chain to allow for transparency when resolving disputes in the case of problems occurring which result in problems with the end-service or product delivered to the end-customer. These requirements can be met by the use of a distributed ledger.

### SUMMARY OF THE INVENTION

However, in a distributed ledger, all participants in the distributed ledger are able to maintain a complete copy of the entire ledger and are therefore able to access any of the data stored therein. It is therefore very difficult to enforce constraints on access to the data stored in the distributed ledger to restrict access to certain data under certain conditions. One case where it would be desirable to be able to restrict access to data unless certain conditions have been met is in order to meet data sovereignty requirements. Data sovereignty is the concept that data should be subject to the requirements of the nation within which the data was collected. These requirements are commonly embodied in the laws of the countries concerned. The requirements may vary depending on the type of data. For example, data that is considered to be personal in nature may be required to be handled in particular ways, whilst other types of data may have other requirements (or even no specific requirements).

In an inventory management system, the attributes that are recorded for items (i.e. digital twins of physical assets) in the inventory management system may comprise attributes representing types of data to which data sovereignty requirements are applicable. It may therefore be necessary to ensure that access to those attributes are restricted to entities that meet various conditions (such as being located in a territory with appropriate legal safeguards for processing such data as determined by the data sovereignty requirements of the jurisdiction in which the data of those attributes was recorded). For example, some data items may have attributes for recording a name of a customer to which each item belongs, possibly together with other attributes for recording personal data about that customer (such as a customer's address where the equipment is located). It may therefore be necessary to ensure that any entity with access to those attributes on that data item meet the necessary conditions to satisfy the data sovereignty requirements.

Accordingly, it would be beneficial to mitigate these disadvantages.

In a first aspect of the invention, there is provided a data access control system comprising: a policy store comprising one or more policies for controlling access to at least some of the data recorded in a distributed ledger that is shared amongst a plurality of computing nodes, each policy comprising one or more constraints on accessing the data; a key store for storing cryptographic keys; a transaction processor configured to: receive a transaction from one of the computing nodes; encrypt a payload of the transaction using a secret key to generate an encrypted transaction for recording in the distributed ledger; and store the secret key in the key store in association with an indication of the encrypted transaction; and a data access module configured to: receive a request for access to the payload of the encrypted transaction from one of the computing nodes; determine whether the constraints specified by the one or more policies on accessing data contained in the payload are satisfied; and in response to determining that the constraints are satisfied: retrieve the secret key from the key store; and use the secret key to provide access to the data for the computing node.

The one or more constraints specified by each policy may comprise one or more geographical constraints on locations from which the data can be accessed. The data access module may be configured to determine whether the constraints are satisfied by determining whether a location associated with the requesting computing node satisfies the geographical constraints.

The request for access to the payload of the encrypted transaction may comprise a location token obtained by the requesting computing node from a location service that is configured to provide a computing node with a token attesting to a location of the computing node at a point in time at which the token was requested.

The transaction processor may be further configured to determine a location of the computing node that initiated the transaction. The encrypted transaction may further comprise an indication of the location of the computing node that initiated the transaction. The geographical constraints of the one or more policies are dependent on the location of the computing node that initiated the transaction. The transaction processor may be further configured to: receive a location token obtained by the computing node that initiated the transaction from a location service that is configured to provide a computing node with a token attesting to a location of the computing node at a point in time at which the token was requested; and determine the location of the computing node based on the location attested to by the token.

The system may form part of an inventory management system and the distributed ledger may comprise digital representations of one or more inventory items.

The transaction processor may be configured to process the transaction in a trusted execution environment such that the payload of the transaction is not available to the system after the transaction has been processed.

In a second aspect of the invention, there is provided a computer implemented method of processing transactions to be recorded in a distributed ledger that is shared amongst a plurality of computing nodes, the method comprising: receiving a transaction from one of the computing nodes; encrypting a payload of the transaction using a secret key to generate an encrypted transaction for recording in the distributed ledger; and storing the secret key in association with an indication of the encrypted transaction.

The method may further comprise determining a location of the computing node that initiated the transaction. The encrypted transaction may further comprise an indication of the location of the computing node that initiated transaction.

The method may further comprise receiving a location token obtained by the computing node that initiated the transaction from a location service configured to provide a computing node with a token attesting to a location of the computing node at a point in time at which the token was requested. The location of the computing node may be determined to be the location attested to by the token.

In a third aspect of the invention, there is provided a computer implemented method of controlling access to data recorded in a distributed ledger that is shared amongst a plurality of computing nodes, the method comprising: receiving a request for access to the payload of an encrypted transaction from one of the computing nodes; determining whether constraints on accessing data contained in the payload that are specified by one or more policies are satisfied; and in response to determining that the constraints are satisfied: retrieving a secret key that was used to encrypt the payload of the encrypted transaction; and using the secret key to provide access to the data for the computing node.

The constraints may comprise one or more geographical constraints on locations from which the data can be accessed. Determining whether the constraints on access data the data contained in the payload are satisfied may comprise determining whether a location associated with the requesting computing node satisfies the geographical constraints.

The request for access to the payload may comprise a location token obtained by the requesting computing node from a location service configured to provide a computing node with a token attesting to a location of the computing node at a point in time at which the token was requested.

Each transaction may comprise an indication of a location of the computing node that initiated the transaction. The geographical constraints specified by the one or more policies may be dependent on the location of the computing node that initiated the transaction.

The distributed ledger may comprise digital representations of one or more inventory items.

In a fourth aspect of the invention, there is provided a computer system comprising a processor and a memory storing computer program code for performing the method of the second or third aspects.

In a fifth aspect of the invention, there is provided a computer program which, when executed by one or more processors, is arranged to carry out the method of the second or third aspects.

### BRIEF DESCRIPTION OF THE FIGURES

Embodiments of the present invention will now be described by way of example only, with reference to the accompanying drawings, in which:

FIG. 1 is a block diagram of a computer system suitable for the operation of embodiments of the present invention.

FIG. 2 is a schematic diagram of an arrangement of computer systems within which embodiments of the invention may operate.

FIG. 3 is a flowchart illustrating a method of processing transactions to be recorded in a distributed ledger in accordance with embodiments of the invention.

FIG. 4 is a flowchart illustrating a method of controlling access to data recorded in a distributed ledger in accordance with embodiments of the invention.

### DETAILED DESCRIPTION OF EMBODIMENTS

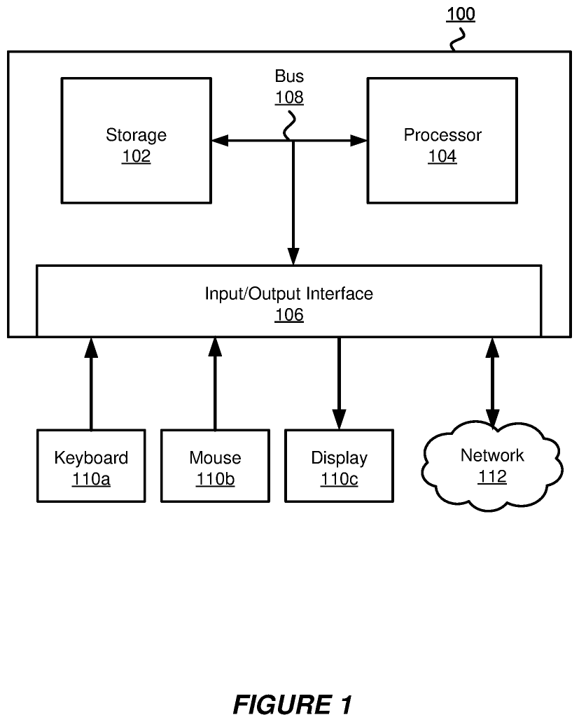

FIG. 1 is a block diagram of a computer system 100 suitable for the operation of embodiments of the present invention. The system 100 comprises: a storage 102, a processor 104 and an input/output (I/O) interface 106, which are all communicatively linked over one or more communication buses 108.

The storage (or storage medium or memory) 102 can be any volatile read/write storage device such as a random access memory (RAM) or a non-volatile storage device such as a hard disk drive, magnetic disc, optical disc, ROM and so on. The storage 102 can be formed as a hierarchy of a plurality of different storage devices, including both volatile and non-volatile storage devices, with the different storage devices in the hierarchy providing differing capacities and response times, as is well known in the art.

The processor 104 may be any processing unit, such as a central processing unit (CPU), which is suitable for executing one or more computer programs (or software or instructions or code). These computer programs may be stored in the storage 102. During operation of the system, the computer programs may be provided from the storage 102 to the processor 104 via the one or more buses 108 for execution. One or more of the stored computer programs, when executed by the processor 104, cause the processor 104 to carry out a method according to an embodiment of the invention, as discussed below (and accordingly configure the system 100 to be a system 100 according to an embodiment of the invention).

The input/output (I/O) interface 106 provides interfaces to devices 110 for the input or output of data, or for both the input and output of data. The devices 110 may include user input interfaces, such as a keyboard 110a or mouse 110b as well as user output interfaces such as a display 110c. Other devices, such a touch screen monitor (not shown) may provide means for both inputting and outputting data. The input/output (I/O) interface 106 may additionally or alternatively enable the computer system 100 to communicate with other computer systems via one or more networks 112. It will be appreciated that there are many different types of I/O interface that may be used with computer system 100 and that, in some cases, computer system 100 may include more than one I/O interface. Furthermore, there are many different types of device 100 that may be used with computer system 100. The devices 110 that interface with the computer system 100 may vary considerably depending on the nature of the computer system 100 and may include devices not explicitly mentioned above, as would be apparent to the skilled person. For example, in some cases, computer system 100 may be a server without any connected user input/output devices. Such a server may receive data via a network 112, carry out processing according to the received data and provide the results of the processing via a network 112.

It will be appreciated that the architecture of the system 100 illustrated in FIG. 1 and described above is merely exemplary and that other computer systems 100 with different architectures (such as those having fewer components, additional components and/or alternative components to those shown in FIG. 1) may be used in embodiments of the invention. As examples, the computer system 100 could comprise one or more of: a personal computer; a laptop; a tablet; a mobile telephone (or smartphone); a television set (or set top box); a games console; an augmented/virtual reality headset; a server; or indeed any other computing device with sufficient computing resources to carry out a method according to embodiments of this invention.

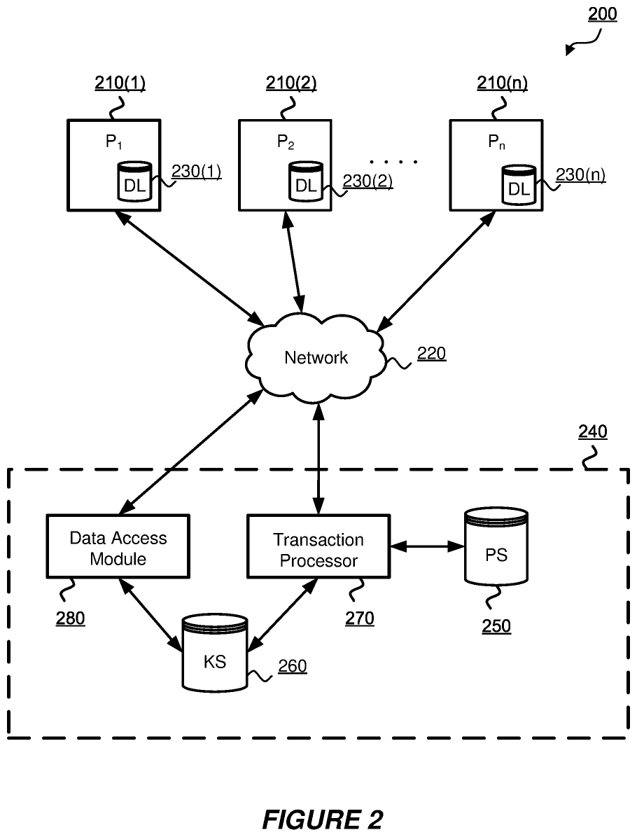

FIG. 2 is a schematic diagram of an arrangement 200 of computer systems within which embodiments of the invention may operate. The arrangement 200 comprises a plurality of computing nodes 210 (or computer systems, such as computer system 100), which are communicatively coupled via a network 220.

Although network 220 is illustrated as a single component in FIG. 2, it will be appreciated that multiple networks may be used to communicatively couple the nodes 220. Furthermore, any suitable type(s) of network may be used.

The computing nodes 210 are configured to share a distributed ledger (DL) 230 such that each of the computing nodes 210(1)-210 (n) maintains its own respective copy 230(1)-230 (n) of the distributed ledger in a manner that will be familiar to those skilled in the art. The computer nodes 210(1)-210 (n) (which may also be referred to as participant nodes) can add transactions to the ledger by submitting them for verification by one or more of the other computing nodes 210(1)-210 (n) involved in operating the distributed ledger 230 in accordance with a consensus algorithm. Once verified, the transaction is broadcast to all of the computing nodes 210 so that each computing node 210(1)-210 (n) can add the transaction to their own respective copy 230(1)-230 (n) of the distributed ledger (which may also be considered to be a transaction log). In some cases, the distributed ledger may take the form of a Blockchain. However, any suitable distributed ledger technology may be used. Similarly any suitable form of consensus algorithm may be used. In some cases, the distributed ledger may be public. However, in most cases, a permissioned distributed ledger will be used in which an access control layer restricts access to the distributed ledger to certain authorised participants. As will be appreciated by those skilled in the art, different consensus algorithms may be more suitable for use in permissioned distributed ledgers where all parties are known and trusted (at least to some degree) compared to those that are used for public ledgers. For example, in a permissioned distributed ledger, each of the participating nodes 210(1)-210 (n) may have access to a respective public key for each of the other participating nodes and each node may be required to sign transactions that they initiate using their corresponding private key. Accordingly, a transaction may be verified by another node by using the public key for the computing node 210 that submitted the transaction to verify whether a signature embedded in the transaction is correct (i.e. that it was generated using the corresponding private key).

As an example, the arrangement 200 of computer systems may collectively form an inventory management system. In this case, the distributed ledger may comprise digital representations of one or more inventory items. That is to say, the transactions that are recorded in the distributed ledger relate to actions taken in respect of digital representations of one or more inventory items. As already mentioned, the digital representation may be referred to as a digital twin of an underlying physical inventory item that it corresponds to. The digital representation (or twin) can include various attributes representing properties and state (or configuration) of the physical inventory item. Accordingly, the computing nodes 210(1)-210 (n) can modify the attributes of the digital representation by submitting transactions to the distributed ledger 230 with a payload containing the new value(s) for attributes of the inventory item. The current state of the inventory item (or at least of the digital representation of the inventory item) is given by the sum of all the transactions, processed in order, relating to that inventory item (from its creation through any subsequent modifications). As will be appreciated, there are a wide range of attributes that may be recorded against the inventory items which may also differ between different types of inventory item. As examples, the digital representation may include attributes for recording the owner of the inventory item and a software version of software running on the inventory item, although alternative or additional attributes may be used instead. Accordingly, in such examples, the computing nodes 210(1)-210 (n) can change the recorded ownership of an inventory item by submitting a transaction with a payload that identifies the inventory item and specifies the new owner.

In some cases, the inventory management system may be configured to effect changes to the inventory item based on the attributes specified for its digital twin. In such cases, a computing node with access to the data stored in the distributed ledger 230 carries out the necessary actions with respect to the physical inventory item to make it match the attributes specified for the digital twin. For example, various configuration parameters of a device that is an inventory item may be stored as attributes against the digital representation of the inventory item and a computing device may modify the configuration parameters of the physical inventory item to match the attributes recorded against the digital representation of the inventory item. As another example, a software version of the physical inventory item may be recorded against its digital representation. A computing device may therefore carry out any necessary modification to the software (e.g. applying patches) to make it match the version of software specified against the inventory item's digital representation. In such cases, the inventory item itself may be configured to access the distributed ledger 230 and update itself based on the attributes specified against its digital representation therein. Of course, in other cases, a separate computer system may be responsible for configuring the inventory item. In either case, the computer system responsible can be provided with a read-only access to the distributed ledger 230. That is to say, the computer system may be prevented from successfully submitting transactions to the distributed ledger to update any entries (e.g. because any transactions that are submitted will not be validated under the consensus algorithm being used). Of course it is not absolutely necessary to limit this computer system's access to the distributed ledger 230 and in some cases this computer system may be a full participant of the distributed ledger 230 (i.e. able to both read and write to the distributed ledger 230).

The arrangement 200 further comprises a data access control system 240 for controlling access to data recorded in the distributed ledger 230 in accordance with embodiments of the invention. The data access control system 240 is communicatively coupled to the computing nodes 210 via the network 220. The data access control system 240 comprises a policy store (PS) 250, a key store (KS) 260, a transaction processor 270 and a data access module 280. Although these elements of the data access control system 240 are shown as discrete elements in FIG. 2, it will be appreciated that this need not be the case and that multiple elements (or all of them) may be provided by a single computer system 100.

The policy store 250 stores policies for controlling access to at least some of the data recorded in the distributed ledger 230. In particular, each policy comprises one or more constraints on accessing data.

In some cases, the constraints specified by the policies in the policy store may comprise geographical constraints on locations from which the data can be accessed. That is to say, only computing nodes that are located in a place that satisfies the geographical constraints should be allowed to access the data, whilst other computing nodes should be prevented from accessing the data.

The policies that are applicable may differ depending on the type of data that is being accessed. For example, data that has been identified as being personal data may require the constraints specified by a first set of policies to be specified in order for access to be allowed whilst data of other types may be associated with other sets of policies or, for non-sensitive data may not be associated with any policies (with the consequence that there are no constraints on access to that type of data).

In some cases, the policies may be dependent on the location of the computing node 210 that initiated the transaction (i.e. the location at which the transaction took place) in addition to the location of the computing node 210 that is accessing the data. For example, a transaction that was initiated at a location within a first territory (e.g. country) may be subject to a different policy (or set of policies) than a transaction that was initiated within a different country. For example, the constraints applicable to transactions initiated in the first territory may require that the data can only be accessed within that first territory whilst constraints applicable to transactions initiated in a second territory may allow the data to be accessed by any computing node provided that the computing node is operated by an entity that has been certified as meeting certain data processing requirements (regardless of the location from which the data is being accessed).

The key store 260 stores cryptographic keys that are generated by the transaction processor 270 so that they can be later used by the data access module 280 as will be discussed in more detail below. Each of the cryptographic keys is stored in the key store 260 in association with an identifier of a transaction to which it relates (such as a unique ID for the transaction). The key store is suitably secured such that the computing nodes 210(1)-210 (n) cannot directly access the cryptographic keys stored therein.

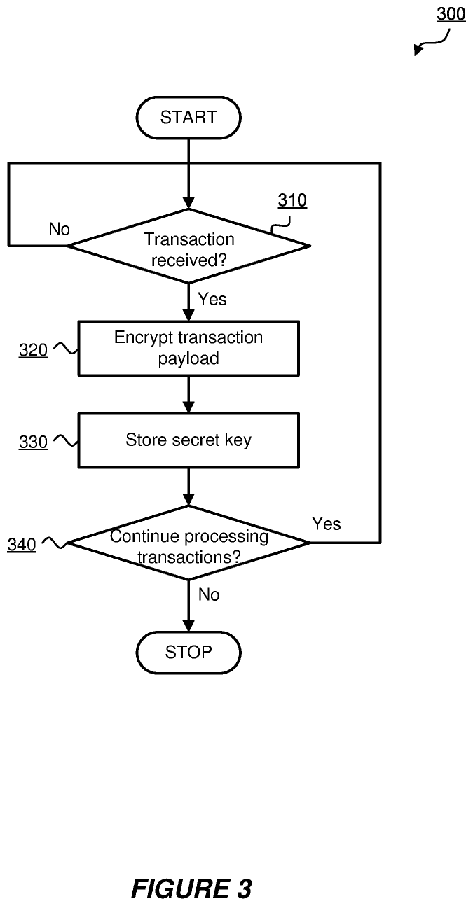

The transaction processor 270 is configured to process transactions that are provided by the plurality computing nodes 210. Specifically, the transaction processor 270 processes the transactions so as to preserve the privacy of data that is subject to access constraints from the other computing nodes 210 with which the distributed ledger is shared. The operation of transaction processor 260 will now be discussed further with reference to FIG. 3 which is a flowchart illustrating a method 300 of processing transactions to be recorded in a distributed ledger in accordance with embodiments of the invention. As will be appreciated by those skilled in the art, the operations performed as part of this method may be embodied in a smart contract (although this is not necessary).

At an operation 310, the method 300 receives a transaction from one of the computing nodes 210(1)-210 (n). The transaction that is received is a transaction that the computing node 210 from which it was received (which may also be referred to as the initiating computing node) wants to record to the distributed ledger 230 but which contains data which should be kept private from the other computing nodes 210 unless they meet certain constraints (as set out by policies in the policy store 250).

In some cases, the method 300 may gather additional information about the initiating computing node, such as by determining a location of that computing node. This additional information can be used later on by the Data Access Module 280 when deciding whether to allow access to data, as will be discussed further below. One way in which the location of the computing node 230 can be determined is by requiring the computing node to provide a token that it has obtained from a trusted location service (or “location oracle”). This token may be encoded as part of the location of the transaction that is provided to the transaction processor 270.

The trusted location service is a service that can be run by a network operator which issues tokens attesting to the location of a computing node at a point in time at which the token was requested. The location tokens include an indication of an identity of the computing node that requested it, a location of the computing node that has been determined by the location service and a timestamp. The tokens are cryptographically signed by the trusted location service so that third parties receiving a location token (which in this case is the transaction processor 270) can verify that the token was issued by the trusted location service and has not been tampered with (e.g. to specify a different location or identity of another computing node). Accordingly, the transaction process can use the location token provided by the computing node that initiated the transaction to reliably determine a location of that computing node (e.g. by verifying that the cryptographic signature is that of a trusted location service, that the computing device indicated by the token is the initiating computing node and that the timestamp is relatively recent).

The trusted location service can use any suitable technique for determining the location of a computing node to which it issues a location token. For example, where the computing node is connected to the network via a wired connection, the location service may be able to determine the location of the computing device based on an identity of the particular network connection (or line) used to connect to the network. Alternatively, where a wireless connection is used, the trusted location service may determine that the computing device is located within range of the location of the particular base station or access point through which the computing device is connected (e.g. a Wi-Fi access point, mobile base station, Bluetooth beacon or LORA base station). More advanced techniques may make use of signal strength and/or measurements from multiple base stations or access points in order to more accurately determine the computing device's location. Yet other techniques may incorporate a “crowd sourcing” approach by querying other devices which have been reported as being nearby to verify whether the computing device is in the vicinity of those devices.

As an alternative to requiring the initiating computing node 210 to provide a location token from a location service, in some cases, the transaction processor 270 may perform similar techniques to those that can be performed by the location service to determine a location of the initiating computing node for itself. The transaction processor 270 may then embed an indication of the location of the initiating computing node into the transaction metadata so that it will be recorded in the distributed ledger 230.

In any case, regardless of whether any additional information is gathered about the initiating computing node, having received the transaction, the method 300 proceeds to an operation 320.

At operation 320, the method 300 encrypts a payload of the transaction using a secret key to generate an encrypted transaction. The encrypted transaction is then recorded in the distributed ledger 230.

Any suitable cryptographic technique, whether symmetric or asymmetric can be used. For example, the payload may be encrypted using a public key of a public/private key pair such that the private key of the pair is needed in order to decrypt it. Ideally a different key should be used for each transaction. Accordingly a key may be randomly (or pseudo randomly) generated for each transaction.

In some cases, the data access control system 240 may have access to the distributed ledger 230 such that it can record the encrypted transaction in the ledger itself (provided that it is successfully validated by the consensus algorithm). In other cases, the data control system 240 may not have access to the distributed ledger 230, in which case it may provide the encrypted transaction back to the initiating computer node 210 to allow that node 210 to cause the encrypted transaction to be recorded in the ledger.

It should be noted that although the payload of the encrypted transaction is encrypted, the metadata for the transaction (such as the transaction id, an identification of the initiating node, the timestamp and location of the transaction and the cryptographic signature) is not encrypted. Therefore, when the encrypted transaction is recorded in the distributed ledger 230, the other computing nodes 210 can validate the transaction, even though they are unable to access the data contained in the payload of the transaction. That is to say, the signature of the transaction in the system can be based solely on the transaction metadata (i.e. excluding the payload) such that encryption of the payload does not invalidate the signature.

Having generated the encrypted transaction for recording in the distributed ledger 230, the method 300 proceeds to an operation 330.

At operation 330, the method 300 stores the secret key in the key store 260 in association with an indication of the encrypted transaction (such a transaction ID). The transaction processor 270 can then remove any record of the original transaction from its memory. This means that the only way to access the data contained in the payload of the original transaction is to retrieve the secret key from the key store 260 and use it to decrypt the encrypted transaction that has been recorded in the distributed ledger 230.

In some cases, in order to improve security, the method 300 may be performed by the transaction processor 270 within a trusted execution environment (TEE). This means that the only data that will be available outside of the TEE is the keys that have been stored in the key store. Furthermore, by carrying out the processing within a TEE, remote attestation can be used by remote parties (such as the computing nodes 210) to verify the operation of the transaction processor before providing any sensitive data for processing. The results of such verification may also be published to the distributed ledger 230 which, when the method 300 performed by the transaction processor is embodied in a smart contract, provides a high degree of transparency into the operations of the transaction processor 270 without any reduction to the privacy of the data contained in the payload of an encrypted transaction.

Having stored the secret key, the method 300 proceeds to an operation 340.

At operation 340, the method 300 determines whether to continue processing transactions. If so, it reiterates back to operation 310 to process another transaction. Otherwise, the method 300 ends. It is expected that the transaction processor 270 will typically run as a service, continuing to process transactions as requested by the computing nodes 210(1)-210 (n) (though this need not be the case). Furthermore, it will be appreciated that multiple instances of method 300 may be run simultaneously by transaction processor to process multiple transactions substantially in parallel.

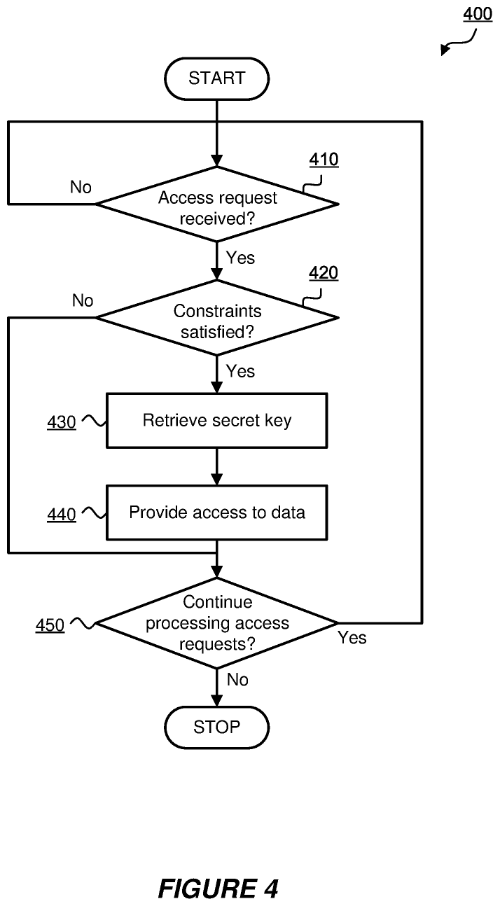

The data access module 280 is configured to control access to the data recorded in the distributed ledger 230. Specifically, the data access module 280 enables the computing nodes 210(1)-210 (n) to access the payload(s) of the encrypted transaction(s) that were encrypted by the transaction processor 270 provided that any applicable constraints set out in the policies stored in the policy store 250 have been satisfied. The operation of the data access module 280 will now be discussed further with reference to FIG. 4 which is a flowchart illustrating a method 400 of controlling access to data recorded in a distributed ledger in accordance with embodiments of the invention. As described for the method 300 that is performed by the transaction processor 270, the method 400 may be embodied in a smart contract (although again this is not necessary) and/or performed within a trusted execution environment (TEE) in order to provide security and transparency regarding the operations of the data access module 280.

At an operation 410, the method 400 receives a request for access to the payload of an encrypted transaction from one of the computing nodes 210.

Where the policies stored in the policy store 250 comprise geographical constraints, the request comprises a location token obtained by the requesting computing node from a trusted location service. As already discussed above, a trusted location service can be provided which is configured to provide a computing node with a token attesting to a location of the computing node at a point in time at which the token was requested. Accordingly, the provision of a location token with the request enables the data access module 280 to reliably determine a current (or at least very recent) location of the requesting computing node 210. Alternatively, instead of the requesting computing node 210 providing a location token, the data access module 280 may be configured to make use of the same techniques as described in relation to the trusted location service to determine the location of the requesting computing node 210 for itself (e.g. by determining a location based on the location of a base station through which the requesting computing node is connected).

Where the data access control system 240 has access to the distributed ledger 230, the request for access to the payload of an encrypted transaction may simply identify the transaction in the distributed ledger (e.g. through the use of a transaction ID). The data access module may then retrieve the encrypted transaction from its copy of the distributed ledger 230. However, where no such access to the distributed ledger 230 is provided, the requesting computing node 210 may provide a copy of the encrypted transaction to the data access control system 240.

In any case, having received the request, the method 400 proceeds to an operation 420.

At operation 420, the method 400 determines whether any constraints on accessing data contained in the payload that are specified by policies stored in the policy store 250 are satisfied. That is to say, the method 400 evaluates the policies in the policy store 250 to determine whether they are applicable and, if they are applicable, whether their constraints have been met.

As already discussed, the constraints that are applicable may be dependent on the location of the computing node 210 that originally initiated the transaction. Accordingly, the location of that computing node 210 may be used when evaluating the policies to determine which constraints are applicable before determining whether those constraints are satisfied by the computing node 210 that is requesting access to the data.

Where the constraints comprise one or more geographical constraints on locations from which the data can be accessed, the method 400 determines whether the location of the requesting computing node (as determined in operation 410) satisfies those constraints. As discussed, the location of the node that initiated the transaction may be indicated within the encrypted transaction, such as through the inclusion of a location token obtained from a trusted location service stored in a location attribute of the transaction.

Accordingly, in some cases, both the location of the computing node that initiated the transaction and the location of the computing node accessing the transaction are taken into account when evaluating whether access to the data can be granted.

Where the constraints on accessing the data are satisfied by the requesting computing node 210, the method 400 proceeds to an operation 430. Otherwise, the method 400 proceeds to an operation 450.

At operation 430, the method 400 retrieves a secret key that was used to encrypt the payload of the encrypted transaction from the key store 260. As already discussed, the key is stored in association with an identifier of the transaction to which it relates. Therefore, the method 400 can use the identifier indicated with the request to access the data (or embedded within the encrypted transaction when the encrypted transaction is provided to the data ace module 280 by the requesting computing node 210) to retrieve the correct key for decrypting the data.

As will be appreciated, where asymmetric encryption is used, the key may be a key pair comprising a public key that was used to encrypt the data and a private key that can be used to decrypt it. These may be considered as separate parts of the same key. In some cases, both parts of the key (or key pair) may be stored in the key store 260. However, in other cases the public part of the key (or public key) may be discarded after the data has been encrypted, as it is no longer needed after that point. Either way, so long as the method 400 can retrieve the private part of the key from the key store 260, the data stored in the payload of the encrypted transaction can be decrypted.

Having retrieved the secret key that can be used to decrypt the payload of the encrypted transaction, the method 400 proceeds to an operation 440.

At operation 440, the method 400 uses the secret key to provide access to the data for the computing node 210. In some cases, access is provided by simply sharing the secret key with the requesting computing node 210. This means that the requesting computing node 210 can decrypt the payload of the transaction itself. It also means that the data access module 280 does not require access to the encrypted transaction (or its decrypted payload). Alternatively, access can be provided by decrypting the payload of the encrypted transaction and providing the data directly to the requesting node 210. In either case, having provided access to the data, the method 400 proceeds to operation 450.

At operation 450, the method 400 determines whether to continue processing access requests. If so, it reiterates back to operation 410 to process another access request. Otherwise, the method 400 ends. It is expected that the data access module 280 will typically run as a service, continuing to process access requests to encrypted transactions from the computing nodes 210(1)-210 (n) over a long period of time (though this need not be the case). Furthermore, it will be appreciated that multiple instances of method 400 may be run simultaneously by the data access module 280 to process multiple data access requests substantially in parallel.

In this manner, the data access control system 240 can be used to solve a key challenge in using a distributed ledger as part of a distributed system, such as an inventory system, namely how to preserve the privacy of sensitive data in a transparent and auditable manner. In particular, although participants 210 in the distributed system may not ordinarily be provided with access to the content of some data (i.e. the payloads of the encrypted transactions), they are still provided with visibility of the transactions that have occurred. Furthermore, when needed (such as in the case of a dispute regarding an issue in the supply of a complex product or service), access to the sensitive data can be obtained provided that any constraints are respected. Accordingly, the data access control system 240 can be used to enforce requirements such as data sovereignty-especially when making use of a trusted location service to determine the location of computer systems 210 that are participating in the distributed system.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example. Suitably, the computer program is stored on a carrier medium in machine or device readable form, for example in solid-state memory, magnetic memory such as disk or tape, optically or magneto-optically readable memory such as compact disk or digital versatile disk etc., and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention. It will be understood by those skilled in the art that, although the present invention has been described in relation to the above described example embodiments, the invention is not limited thereto and that there are many possible variations and modifications which fall within the scope of the invention. The scope of the present invention includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A data access control system comprising:
a policy store comprising one or more policies for controlling access to at least some of the data recorded in a distributed ledger that is shared amongst a plurality of computing nodes, each policy comprising one or more constraints on accessing the data;
a key store for storing cryptographic keys;
a transaction processor configured to:
receive a transaction from one of the computing nodes;
encrypt a payload of the transaction using a secret key to generate an encrypted transaction for recording in the distributed ledger; and
store the secret key in the key store in association with an indication of the encrypted transaction; and
a data access module configured to:
receive a request for access to the payload of the encrypted transaction from one of the computing nodes;
determine whether the constraints specified by the one or more policies on accessing data contained in the payload are satisfied; and
in response to determining that the constraints are satisfied:
retrieve the secret key from the key store; and
use the secret key to provide access to the data for the computing node.

2. The system of claim 1, wherein:
the one or more constraints specified by each policy comprise one or more geographical constraints on locations from which the data can be accessed; and
the data access module is configured to determine whether the constraints are satisfied by determining whether a location associated with the requesting computing node satisfies the geographical constraints.

3. The system of claim 2, wherein the request for access to the payload of the encrypted transaction comprises a location token obtained by the requesting computing node from a location service that is configured to provide a computing node with a token attesting to a location of the computing node at a point in time at which the token was requested.

4. The system of claim 2, wherein:
the transaction processor is further configured to determine a location of the computing node that initiated the transaction;
the encrypted transaction further comprises an indication of the location of the computing node that initiated the transaction; and
the geographical constraints of the one or more policies are dependent on the location of the computing node that initiated the transaction.

5. The system of claim 4, wherein the transaction processor is further configured to:
receive a location token obtained by the computing node that initiated the transaction from a location service that is configured to provide a computing node with a token attesting to a location of the computing node at a point in time at which the token was requested; and
determine the location of the computing node based on the location attested to by the token.

6. The system of claim 1, wherein the system forms part of an inventory management system and the distributed ledger comprises digital representations of one or more inventory items.

7. The system of claim 1, wherein the transaction processor is configured to process the transaction in a trusted execution environment such that the payload of the transaction is not available to the system after the transaction has been processed.

8. A computer implemented method of processing transactions to be recorded in a distributed ledger that is shared amongst a plurality of computing nodes, the method comprising:
receiving a transaction from one of the computing nodes;
encrypting a payload of the transaction using a secret key to generate an encrypted transaction for recording in the distributed ledger; and
storing the secret key in association with an indication of the encrypted transaction.

9. The method of claim 8, further comprising determining a location of the computing node that initiated the transaction, wherein the encrypted transaction further comprises an indication of the location of the computing node that initiated transaction.

10. The method of claim 9, further comprising receiving a location token obtained by the computing node that initiated the transaction from a location service configured to provide a computing node with a token attesting to a location of the computing node at a point in time at which the token was requested, wherein the location of the computing node is determined to be the location attested to by the token.

11. A computer implemented method of controlling access to data recorded in a distributed ledger that is shared amongst a plurality of computing nodes, the method comprising:
receiving a request for access to the payload of an encrypted transaction from one of the computing nodes;
determining whether constraints on accessing data contained in the payload that are specified by one or more policies are satisfied; and
in response to determining that the constraints are satisfied:
retrieving a secret key that was used to encrypt the payload of the encrypted transaction; and
using the secret key to provide access to the data for the computing node.

12. The method of claim 11, wherein:
the constraints comprise one or more geographical constraints on locations from which the data can be accessed; and
determining whether the constraints on access data the data contained in the payload are satisfied comprises determining whether a location associated with the requesting computing node satisfies the geographical constraints.

13. The method of claim 12, wherein the request for access to the payload comprises a location token obtained by the requesting computing node from a location service configured to provide a computing node with a token attesting to a location of the computing node at a point in time at which the token was requested.

14. The method of claim 12, wherein each transaction comprises an indication of a location of the computing node that initiated the transaction and the geographical constraints specified by the one or more policies are dependent on the location of the computing node that initiated the transaction.

15. The method of claim 8, wherein the distributed ledger comprises digital representations of one or more inventory items.

16. A computer system comprising a processor and a memory storing computer program code for performing the steps of claim 8.

17. A computer program which, when executed by one or more processors, is arranged to carry out a method according to claim 8.
